(19) United States
(12) Patent Application Publication
(10) Pub. No.: US 2007/0274732 A1
(43) Pub. Date: Nov. 29, 2007

(54) Optical Modulation Converter and Method for Converting the Modulation Format of an Optical Signal

(76) Inventors: Antonio D'Errico, San Severo (IT); Ernesto Ciaramella, Roma (IT)

Correspondence Address: COATS & BENNETT, PLLC, 1400 Crescent Green, Suite 300, Cary, NC, 27518, US

(21) Appl. No.: 10/598,701

(22) PCT Filed: Mar. 8, 2005
(86) PCT No.: PCT/EP05/51028

§ 371 Date: Jul. 19, 2007

(30) Foreign Application Priority Data
Mar. 8, 2004 (IT) MI2004A 000442

(51) Int. Cl. H04B 10/06

(52) U.S. Cl. 398/202

(57) ABSTRACT

An optical modulation converter (10) for converting the modulation format of an optical input signal is characterized by a birefringent medium (14), polarization maintaining fibre, with a selected differential group delay between its two main axes of symmetry through which the optical input signal is passed to be separated into two optical components each travelling along one of the main axes of the medium at a different group velocity to thereby convert the modulation format of the input signal. By appropriate selection of the differential group delay imparted by the medium relative to the bit rate of the input signal and by appropriately presenting the input signal relative to the main axes of the medium conversion between different modulation formats can be achieved. These include direct conversion from optical DPSK (Differential Phase Shift Keying) to POLSK (POLarization Shift Keying), DPSK to IM (Intensity-Modulated) through an intermediated conversion to POLSK, POLSK to IMDD (Intensity Modulation Direct Detection), and IM to POLSK.

This invention relates to an optical modulation converter and method for converting the modulation format of an optical signal. The invention also relates to a receiver employing said modulation converter and method for receiving and detecting a modulated optical signal.

In present optical transmission systems, communications traffic is conveyed by optical carriers whose intensity is modulated by the communications traffic, that is the optical carrier is Amplitude Modulated (AM). Generally the communications traffic used to modulate the optical carrier will have a Non Return to Zero (NRZ) format though sometimes it can have a Return to Zero (RZ) format.

Intensity-modulation (IM) is preferred mainly due to the simplicity of the corresponding optical receiver/detector that is based on a photodetector, for example a photodiode, which operates as a simple amplitude threshold detector. For particular applications, in general for the soon coming 40 Gbit/s optical communication systems, it has been proposed to use other modulation formats which have greater immunity against non-linear propagation effects and also for greater polarization mode dispersion (PMD) and chromatic dispersion (CD) tolerance. These characteristics can open the road to a new design of optical transmission systems for example with higher transmission powers and longer sections free of repeaters.

Although these alternative modulation formats are typically taken from specific works in the theory of communications there are often difficulties in applying them directly into real optical communications.

A typical example of such alternative modulation formats is the Differential Phase Shift Keying (DPSK) in which the optical phase of the signal is modulated digitally by a differential encoded sequence. In this case, although the modulator can be simply implemented using known LiNbO₃ (Lithium Niobate) technology, the receiver is very difficult to realize since the phase modulated optical signal cannot be directly detected.

In the prior art, two main solutions have been proposed for detecting a modulated DPSK signal. The first is based on the well known scheme taken directly from coherent communications which requires a local oscillator (a laser in the case of an optical system) which must agree with both the State Of Polarization (SOP) and the signal carrier frequency (wavelength) [“Modulation and demodulation techniques in optical heterodyne PSK transmission” T Chikama et al, J. Lightwave Technol. 8, 3 pgs 309-322 (1990)]. These characteristics make the receiver design both complex and costly. The second scheme is based on a time delay interferometer. The interferometer (typically a Mach Zehnder interferometer) is an optical component that can be used for converting the DPSK signal into an intensity modulation (IM) signal which is then received by means of a conventional IM receiver [“Return to zero modulator using a single NRZ drive signal and optical delay interferometer” P. J. Winzer and J. Leuthold, Photon. Technol. Lett. 13, 12 pgs 1298-1300 (2001)]. However, interferometric structures are difficult to manage (they can suffer critically from environmental fluctuations) and strongly depend on the bias stability [“Principles of Optics: Electromagnetic Theory of Propagation, Interference and Diffraction of Light (7^{th} Edition)” M Born and E Wolf (1999)]. In addition, they are not yet available commercially and only research prototypes are known.

The general purpose of the present invention is to remedy the above-mentioned shortcomings by making available a method and a modulation converter that can be used to easily convert an optical signal modulation format into another format. This allows for example receiving a modulated DPSK optical signal and converting it into an IM signal (RZ or NRZ) ready for electro-optical detection. This is all with the advantage of being able to use known low cost components.

In accordance with a first aspect of the invention there is provided an optical modulation converter for converting the modulation format of an optical input signal which is characterized by a birefringent medium with a selected differential group delay (DGD) between its two main axes of symmetry through which the optical input signal is passed to be separated into two components each travelling along one of the main axes of the medium at a different group velocity.

Advantageously the differential group delay of the birefringent medium is selected on the basis of the optical input signal bit rate such that the differential group delay introduced by the birefringent medium is substantially equal to the bit period of the input signal. Such an arrangement enables conversion of a Phase-Modulated input signal into a corresponding Polarization-Modulated output signal.

Preferably the converter further comprises a polarization controller operable to cancel random polarization fluctuations in the optical input signal before it is applied to the birefringent medium.

For ease of fabrication the birefringent medium advantageously comprises a polarization maintaining fibre whose length is selected to provide the selected differential Group Delay to ensure correct modulation conversion.

Advantageously before the input signal is applied to the birefringent medium it traverses an optical isolator. The optical isolator reduces spurious reflections that might otherwise be present at the input of the birefringent medium and thereby improves stability of the converter.

When the optical input signal to be converted is phase-modulated, the birefringent medium is selected such that the group delay is such that the signal output from the birefringent medium is a corresponding a polarization-modulated signal. Moreover, when the input signal is phase-modulated with a linear polarization, the optical input signal is advantageously coupled at 45° to the main axes of the birefringent medium. Coupling of the input signal can be achieved using a polarization controller provided at the input of the converter.

When a phase-modulated optical input signal is being converted to a polarization-modulated signal the converter advantageously further comprises at the output of the birefringent medium, a second conversion stage comprising a polarization-sensitive device for converting the polarization-modulated signal and into a corresponding intensity-modulated signal. Conversion from a polarization-modulated signal to an intensity-modulated signal is conveniently achieved selected one of the states of polarization of the polarization-modulated signal. Such an intensity-modulated signal can then be readily detected using a known photodetector.

Conveniently the polarization-sensitive device is a polarizer or a polarization splitter for separating the two optical components.

To cancel random polarization fluctuations in the optical signal before it is applied to the polarization-sensitive device, the converter advantageously further comprises a second polarization controller.

Preferably the converter further comprises a photodetector at the output of the second stage for detecting the intensity-modulated signal.

Advantageously when the input signal is phase-modulated, the differential group delay of the birefringent medium is selected such that it is substantially equal to the bit period of the input signal to thereby convert the input signal into a corresponding intensity-modulated non return to zero (IM-NRZ) format. Alternatively, the differential group delay of the birefringent medium is selected such that it is sufficiently less than the bit period of the input signal to thereby convert the phase-modulated input signal into an intensity-modulated return to zero (IM-RZ) format.

According to a second aspect of the present invention there is provided a method for optical conversion of the modulation format of an optical signal which is characterised by passing the optical signal through a birefringent medium with a selected differential group delay between its two main symmetry axes to separate it into two components each travelling along one of the main axes of the medium at a different group velocity.

Advantageously when the input signal to be converted is phase-modulated, the differential group delay of the birefringent medium is selected such that the signal output by the birefringent medium is a corresponding polarization-modulated signal.

Preferably the method further comprises applying the polarization-modulated signal to a polarization-sensitive device to convert it into an intensity-modulated signal.

Advantageously the method further comprises selecting the differential group delay of the birefringent medium on the basis of the bit rate of the optical input signal such that it is substantially equal to the signal bit period.

In accordance with a further aspect of the invention there is provided an optical signal receiver for detecting an phase-modulated optical input signal which is characterised by a first optical signal modulation format conversion stage comprising a birefringent medium with selected differential group delay between its two main symmetry axes through which the optical signal is passed to separate it into two components each travelling along one of the main axes of the medium at a different group velocity to obtain a corresponding polarization-modulated signal; a second conversion stage comprising a polarization-sensitive device for converting the polarization-modulated signal into a corresponding intensity-modulated signal and a photodetector device for detecting the intensity-modulated signal.

In order that the invention and its advantages compared with the prior art can be better understood, there is described below with the aid of the accompanying drawings a possible embodiment thereof by way of non-limiting example.

In the drawings:

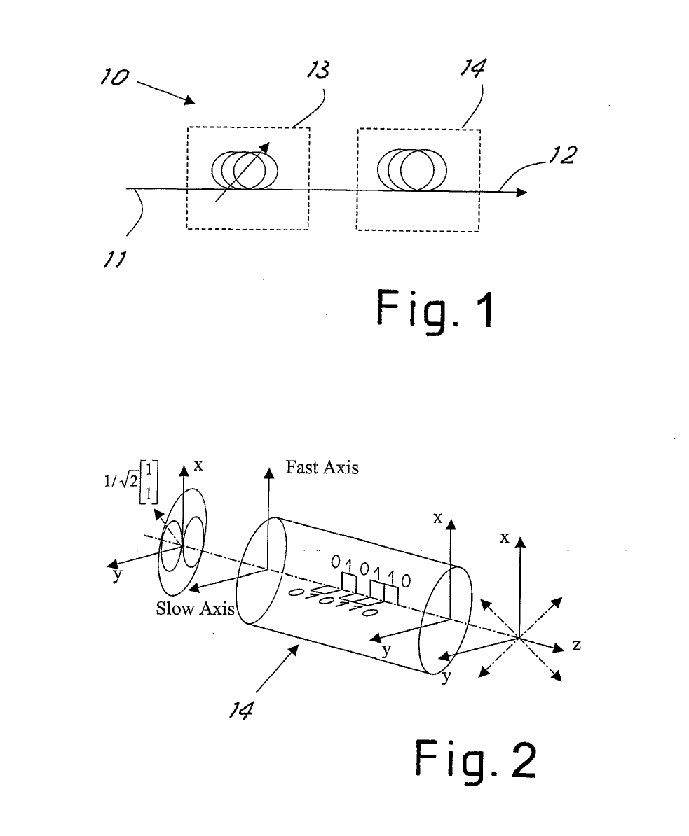

FIG. 1 shows a block diagram of an optical converter in accordance with the present invention for optical conversion of the modulation format of an optical input signal;

FIG. 2 represents the evolution of a Differential Phase Shift Keying (DPSK) optical signal along a birefringent medium that is part of the optical converter in accordance with the present invention;

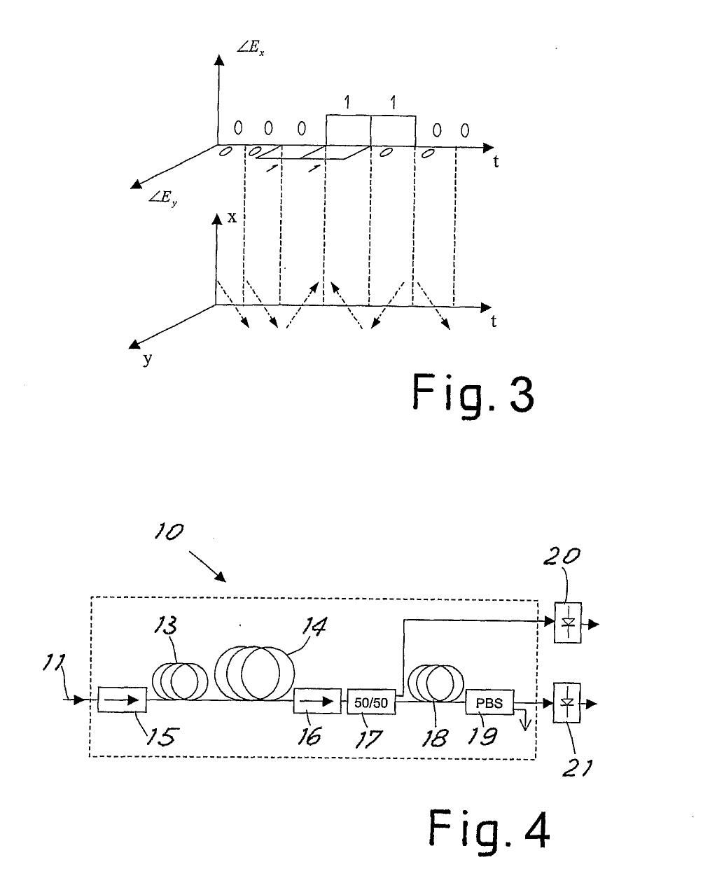

FIG. 3 illustrates conversion of a DPSK signal into a Polarisation Shift Keying (POLSK) signal in accordance with the present invention;

FIG. 4 shows a block diagram of an optical converter/receiver in accordance with a first embodiment of the invention for converting a DPSK modulated input signal into an IM output signal;

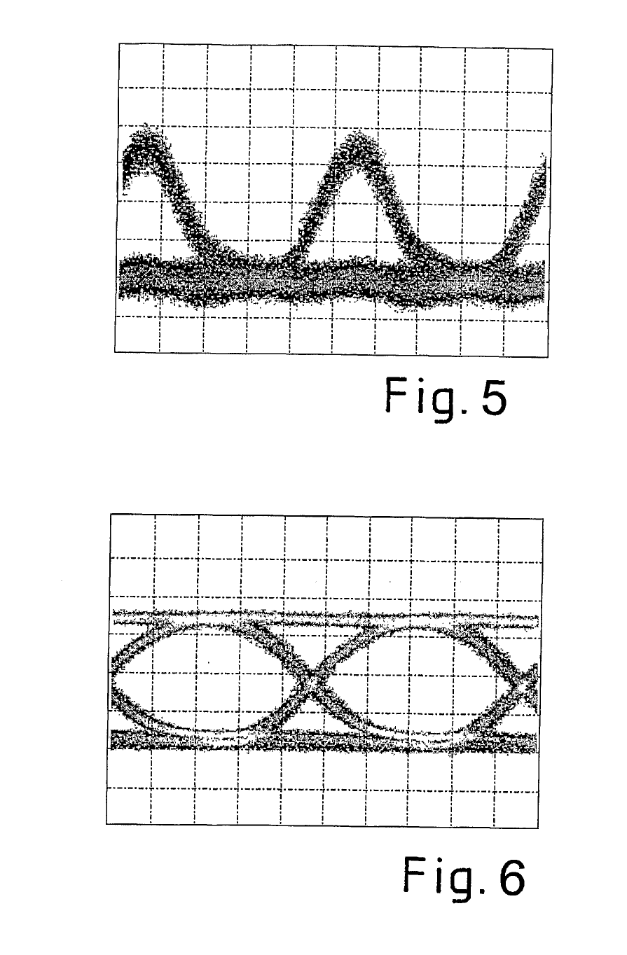

FIGS. 5 and 6 are measured eye diagrams (amplitude/intensity versus time) for a DPSK input signal converted using the optical converter/receiver arrangement of FIG. 4; and

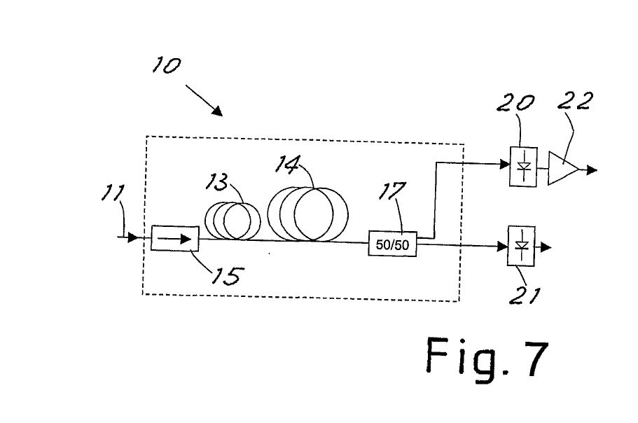

FIG. 7 shows a block diagram of an optical converter and a receiver in accordance with a second embodiment of the invention.

With reference to the figures, a new modulation conversion idea enjoying the advantages of being simple and flexible is now described.

Referring to FIG. 1 there is shown a schematic representation of an optical modulation converter in accordance with the present invention that is designated as a whole by reference numeral 10. The optical modulation converter 10 is for optically converting the modulation format of an optical signal received an optical input 12 into a corresponding optical signal having a different modulation format which is output from an optical output 13. The converter comprises a known polarization controller 13 and a Birefringent Medium 14 connected in series between the optical input 11 and an optical output 12. Conveniently the birefringent medium comprises a selected length of Polarization Maintaining Fibre (PMF).

As will now be described the use of a birefringent medium in accordance with the innovative principles of the invention eliminates need for any optical interferometer for modulation format conversion. The birefringent medium is utilized to split the optical input signal into two orthogonal polarization components each travelling one of the principal (main) axes of the birefringent medium. The two principal axes (denoted Fast and Slow axes respectively) have different respective phase velocities. As a result the birefringence introduces a Differential Group Delay (DGD) between the two principal axes of symmetry so that the two components propagate through the medium with different group velocity and phase velocity. Hence, if the optical signal at the input of the birefringent medium has a definite state of polarization (for example linear polarization) and is coupled at a suitable angle (for example 45°) to the principal axes of the medium, both signal components will have the same power. In the embodiment shown in FIG. 1 the polarization controller ensures that the optical input signal is presented to the birefringent medium in a known polarisation state relative to the principal axes of the medium. After propagation through the medium the two components emerge at the output with a significant relative delay and also with an optical phase difference (both due to the medium birefringence). Since these signal components are combined at the end of the birefringent medium the final output optical signal has a complex dependence on the input signal and the delay and the optical phase difference introduced by the medium. As will be elucidated below, passing an optical signal having a first modulation format through a birefringent medium can enable at least a first stage of the conversion to a different modulation format.

A generic signal at the input of the birefringent medium can be represented as follows:

$$\vec{E} ( t ) = ( {E}_{0 , x} \vec{x} + {E}_{0 , y} \vec{y} ) {ⅇ}^{ⅈΦ ( t )}$$

$$with$$

$$Φ ( t ) = π {\sum }_{k} {a}_{k} q ( t - {kT}_{bit} )$$

$$and$$

$${a}_{k} = 0 , 1 ;$$

$$q ( t ) = \{ \begin{matrix}1 & for \vert t \vert \leq ( {T}_{bit} / 2 ) \\ 0 & for other values of t\end{matrix}$$

where x and y indicate the two orthogonal polarizations of the birefringent medium; Φ(t) is the phase modulation; T_{bit} is the bit period (time) of the input signal and E_{0,x} and E_{0,y} are complex amplitudes whose values determine the State of Polarization (SOP) of the signal (for example if both are real numbers, the light is linearly polarized). If α=π/2 and the light is linearly polarized, E_{0,x}=E_{0,y}.

After propagation through the birefringent medium the field becomes:
\vec{E}(t)=E_{0,x}e^{iΦ(i-T+ΔT/2)+iψ/2}\vec{x}+E_{0,y}e^{iΦ(t-T-ΔT/2)-iψ/2}\vec{y} (1)
where T is the mean group delay and ΔT and ψ are the differential group delay and phase delay respectively.

Conversion requires an optical input signal with a known, fixed State of Polarization (SOP). To cancel random polarization fluctuations in the input signal, these are usually introduced during transmission over a transmission optical fibre, the polarization controller 13 (possibly with suitable software and/or hardware controllers) is provided at the input of the modulation converter. Polarization controllers are well known to those skilled in the art and not further described or shown.

In addition to a polarization controller, an optical isolator is advantageously provided at the input of the converter to reduce spurious reflections that might otherwise be present at the input of the birefringent medium. The use of an optical isolator can improve the stability of the converter as will explained below.

The principle of how a birefringent medium can be used to convert the modulation format of an optical signal will now be further explained with reference to conversion of a DPSK signal to a corresponding POLSK signal. Referring to FIG. 2, this shows diagrammatically the evolution of a DPSK (Differential Phase Shift Keying) signal along the birefringent medium (in particular a PMF fibre). On the left of the figure is shown diagrammatically the signal input to the fibre while the result obtained at output is shown diagrammatically on the right.

In this example, the input signal is DPSK modulated at 10 Gbit/s with a linear polarization state. The input signal is coupled at α=45° to the principal axes x, y of the birefringent medium. The phase modulation of the input signal is:

$$Φ ( t ) = \{ \begin{matrix}0 & if & bit & ‘ 1 ’ \\ π & if & bit & ‘ 0 ’\end{matrix}$$

If such a DPSK signal is presented to the input of the birefringent medium and the differential group delay ΔT is on the order of bit period T_{bit} of the input signal, the output from the medium will be a polarization-modulated signal, whose modulating signal is the original signal i.e. it will also be differentially decoded.

It will be appreciated that the two polarization states of the output signal depend on the phase difference of the DPSK and the characteristics of the birefringent medium. This means that if the optical phase delay, shift, ψ introduced by the birefringent medium is π and the differential group delay ΔT is substantially equal to the bit period T_{bit}, two orthogonal polarizations can be produced in the output signal i.e. a binary POLSK (POLarization Shift Keying). Furthermore this POLSK signal can then be converted into a corresponding intensity-modulated (IM) signal using a second conversion stage and the IM signal then readily detected using a photodetector (photodiode) that is operated as a threshold detector.

The second conversion stage (POLSK to IM) comprises a polarization-sensitive device (PSD), for example a polarizer or a polarization splitter, for selecting only one of the two polarization states and thereby produce a corresponding IM signal. In order to align the states of polarization (SOP) of the POLSK signal with the axes of the PSD it is advantageous to further include a polarisation controller between the birefringent medium and the PSD. Thus where it is desired to realize a phase-modulated signal receiver (DPSK or PSK) the PSK optical signal is firstly converted to a POLSK signal using a birefringent medium and then secondly converted to an IM signal that can then be detected by a normal photodiode with adequate pass-band.

It will be appreciated that the modulation conversion of the invention eliminates the need for differential or coherent receiver schemes and can be implemented using readily available optical components.

The birefringent medium is selected on the basis of the input signal bit rate such that the Differential Group Delay ΔT introduced by the medium is comparable to, or substantially equal to, the bit period (time) T_{bit} of the input signal (T_{bit}=1/bit rate). For example for an input signal with a bit rate of 10 Gbit/s the bit period T_{bit}=100 ps and if a Polarization Maintaining Fibre (PMF) is used as the birefringent medium which has a linear delay of 0.2 ps/m, the two components will be delayed by a bit period after propagating through 50 metres of PMF.

For example starting from the equation (1) it can be shown that a phase-modulated (DPSK) signal can be converted into a polarization-modulated (POLSK) signal. Assuming the DPSK phase-shift is exactly π and ΔT=T_{bit}, two orthogonal SOP signals can be produced. The output is:
\vec{E}(t)=e^{iΦ(t′)}(E′_{0,x}\vec{x}+E′_{0,y}e^{i(Φ(t′-ΔT)-Φ(t′))}\vec{y})
where
t=t−T+ΔT/2
E′_{0,x}=E_{0,x}e^{iψ/2}; E′_{0,y}=E_{0,y}e^{-iψ/2}

As can be seen, if ΔT=T_{bit}, the output SOP is determined by the phase shift between two consecutive bits which is:
Φ(t′−ΔT)−Φ(t′)=Φ(t′−T_{bit})−Φ(t′)
and consequently differential optical decoding can be accomplished. These two possible output SOPs depend on the value of Φ(t′−ΔT)−Φ(t′) and will not be aligned with the axes of the birefringent medium (in this example they are at ±45° respectively). Conversion from DPSK to POLSK is obtained thus.

This is clarified further in FIG. 3 in which the upper portion of the figure shows the signal phases compared on the two axes in the birefringent medium and the lower potion of the figure the Jones vectors at the output of the medium. It will be clear that conversion of the DPSK signal into a POLSK signal is due to subdivision and delay of the DPSK signal by the birefringent medium. The sequence of binary bits considered as an example in FIG. 3 is the periodic signal 00110011 and a linear differential delay is set to be exactly equal to the bit period T_{bit} (100 ps).

Naturally, due to the reciprocal properties of the optical components, the birefringent medium (PMF) can conversely be used for reverse conversion, i.e. conversion of a POLSK signal into a DPSK signal.

To convert the modulation format from DPSK to IM (or Amplitude Shift Keying ASK) the above-mentioned conversion to POLSK is firstly used and a known Polarization Selective Device (PSD) can then be used to select only one of the output polarization states to obtain the IM signal. A practical implementation of a converter/receiver for converting a DPSK modulated input signal into a corresponding IM output signal is shown in FIG. 4. The converter/receiver 10 comprises serially connected between the optical input 11 and output 12: a first optical isolator 15; a first polarization controller 14, a selected length of polarization maintaining fibre 14 (birefringent medium); a second optical isolator 16; an optical splitter 17; a second polarization controller 18; a Polarization Beam Splitter (PBS) 19 (polarization sensitive device; and a photodetector 21 for detecting the IM signal. A second photodetector 20 is connected to the second output of the optical splitter 17 and is used for monitoring the POLSK converted signal. The DPSK input signal is applied to the polarization controller 13 via the optical isolator 15 to avoid stray reflections and improve stability as mentioned above. The first polarization controller 13 is configured to ensure that the polarization state of the input signal is appropriately aligned with the principal axes of the birefringent medium to ensure correct conversion of the BPSK input signal into a corresponding POLSK signal. The second optical isolator 16 is provided to reduce the effect of stray reflections. The second polarization control device 18 between the birefringent medium 14 and the polarization selective device 19 is operable to align the two SOPs of the POLSK signal with the axes of the polarization beam splitter PBS. The Polarization Beam Splitter (polarization selective device) 19 is operable to split the two polarization states of the POLSK signal such that one SOP passes to the photodetector 21 for detection and the other is output and discarded. As described the polarization selective device can be for example a polarized filter or a polarization splitter. The intensity-modulated signal obtained from the PBS is easily detected using a photodetector such as a photodiode 21. Thus can be realized a simple DPSK signal receiver.

To obtain the IM signal the scheme of FIG. 4 is based on the following reasoning; a permanence of the phase of the DPSK signal leads to the cut off state of polarization (+π/2: a ‘0’ bit is detected) while a variation in phase leads to the permitted state of polarization (−π/2: a ‘1’ bit is detected). The IM signal output is therefore intensity modulated and can have either RZ format or NRZ format depending on the DGD (Differential Group Delay) introduced by the birefringent medium. In particular, if DGD≈T_{bit} (bit period) the converted signal will be an IM-NRZ signal, whereas if DGD<T_{bit} the converted signal will be a IM-NRZ signal. For example referring to FIGS. 5 and 6 there are shown measured eye diagrams (amplitude/intensity versus time) for a DPSK input signal, T_{bit}=100 ps, converted using the optical converter/receiver arrangement of FIG. 4. The input signal comprises a pseudo random binary (PRBS) sequence. In FIG. 5 the DGD of the birefringent medium is less than the bit period (DGD=60 ps) and it can be clearly seen that the resulting output signal, as measured by the photodetector 21, is an IM-RZ signal. Conversely FIG. 6 shows the eye diagram for the same DPSK input signal for the case where the DGD of the medium is substantially equal to the bit period of the input signal (DGD=95 ps) and this shows how the output signal is now an IM-NRZ signal.

Referring to FIG. 7 there is shown a second converter/receiver arrangement in accordance with the invention. In this example the converter is for converting a 10 Gbit/s POLSK input signal into a corresponding IM signal. For consistency like components are denoted using the same reference numerals as those in FIG. 4. The POLSK input signal has two alternative orthogonal linear states of polarization one representing binary state “0” and the other a binary state “1”. The polarization controller 13 is configured so as to present the input signal to the birefringent medium 14 such that the two linear states of polarization (corresponding to “0” and “1” bits respectively) are aligned with (parallel to) a respective one of the principal (Fast and Slow) axes of the medium. In this example, the birefringent medium 14 is a 50 metre length of Polarization Maintaining Fibre which introduces a total DGD of approximately 100 ps. It will be appreciated that a “0” bit will propagate in the birefringent medium faster than a “1” bit because of the different phase velocities associated with the Fast and Slow axes of the PMF. The output signal is therefore a signal with three-level intensity with a bandwidth greater than 10 GHz and is similar to the first derivative of the modulating signal. When the transition in the input bit stream is logic “0” to “1”, |E|² has a peak value due to the superposition of the two possible states of polarization. Conversely when the transition in the input bit stream is “1” to “0”, |E|² has minimum value because of an absence of possible states of polarization. When the logic transition is “0” to “0” or “1” to “1”, i.e. no change in binary state between consecutive bits of the input signal, |E|² has an intermediate value because of the presence of only one of the possible states of polarization (the intermediate value will lie at the midpoint between the maximum and minimum values). The minimum value will be zero if the linear delay is exactly equal to the bit period (i.e. if DGD ΔT=T_{bit}=100 ps).

This last example (POLSK conversion to multi-level IM) illustrates that a birefringent medium can also be used as an encoder. The original POLSK sequence can be decoded by detecting the encoded signal by means of a photodetector (photodiode) 20 (as shown diagrammatically in FIG. 7) with a bandwidth of less than 10 GHz and by means of an amplifier 22 having an appropriate threshold bias—for example equal to the Full Width Half Maximum (FWHM) of the encoded signal and a bandwidth of 7 GHz.

It has been shown that the objectives of the invention have been solved by the use of a birefringent medium to provide conversion of the modulation format of an optical input signal. Such an arrangement provides a simple and economic method of providing modulation conversion. It will be readily appreciated by those skilled in the art that by appropriate selection of the birefringent medium, in particular the differential group delay, and alignment of the state of polarization of the input signal to the principal axes of the medium a number of different modulation conversion can be achieved. For example the invention can be used to convert from DPSK or MSK (Minimum Shift Keying) directly to POLSK; from DPSK or from MSK to IM through an intermediate conversion to POLSK (the IM signal can be IM-RZ or IM-NRZ depending on the Differential Group delay of the medium relative to the bit rate of the input signal); from POLSK to IMDD (Intensity Modulation Direct Detection); or from IM to POLSK. As DPSK is very similar to PSK, less the initial differential encoding, conversions similar to those for the DPSK can be obtained for the PSK.

In accordance with the invention conversion into an intensity-modulated signal enables a receiver to be readily implemented through the inclusion of a photodetector to detect the intensity-modulated signal.

It can be expected that in future networks different modulation formats will coexist so that in some network nodes it might be expedient to optically convert one modulation format into another. The present invention makes it possible to perform this modulation conversion and it will be useful for employment for transforming the signal format transmitted without loss of data and bandwidth.

The foregoing description of embodiments applying the innovative principles of the present invention is given by way of non-limiting examples and modifications can be made without parting from the scope of the invention. For example it will be appreciated that for correct operation of the converter the two split signals in the birefringent medium should maintain a definite group delay and phase difference along the entire birefringent medium. Depending on the characteristics of the birefringent medium, this condition could be crucial since in particular the phase delay could change after a certain period of time because of thermal, mechanical or other effects. Hence, to satisfy this condition it can be preferable to enclose the converter, in particular the birefringent medium, in a suitable enclosure to isolating the birefringent medium from the effects of the external environment. Alternatively or in addition the converter could include a temperature control mechanism, such as for example a Peltier heating/cooling element for maintaining the birefringent medium at a set temperature. Moreover, the converter can be designed so as to keep these variations under control (some of which could be compensated for after the birefringent medium). In the case of polarization maintaining fibre, it can be useful to use the common small synthetic cover preserving the transmission properties of the fibre.

1-18. (canceled)

19. An optical modulation converter configured to convert the modulation format of an optical input signal, the optical modulation converter comprising:
a birefringent medium having first and second main axes of symmetry and a selected differential group delay between the first and second main axes of symmetry, the birefringent medium configured to separate an optical input signal passed through the first and second main axes into two optical components such that each optical component travels along different ones of the first and second main axes at a different group velocity.

20. The converter of claim 19 wherein the birefringent medium is selected based on a bit rate of the optical input signal such that the differential group delay introduced by the birefringent medium is substantially equal to a bit period of the optical input signal.

21. The converter of claim 19 further comprising a polarization controller configured to cancel random polarization fluctuations in the optical input signal before it is received by the birefringent medium.

22. The converter of claim 19 wherein the birefringent medium comprises a polarization maintaining fiber.

23. The converter of claim 19 further comprising an optical isolator operatively coupled to an input of the birefringent medium.

24. The converter of claim 19 wherein the optical input signal to be converted comprises a phase-modulated optical signal, and wherein the birefringent medium is selected such that the selected differential group delay between the first and second main axes of symmetry results in the birefringent medium outputting a corresponding polarization-modulated signal.

25. The converter of claim 19 wherein the optical input signal is coupled at 45° to the first and second main axes of the birefringent medium when the optical input signal comprises a phase-modulated optical signal having a linear polarization.

26. The converter of claim 24 wherein the birefringement medium comprises at least a part of a first conversion stage of the optical modulation converter, and further comprising a second conversion stage operatively connected to the output of the birefringent medium, the second conversion stage including a polarization-sensitive device configured to convert the polarization-modulated signal into a corresponding intensity-modulated signal.

27. The converter of claim 26 wherein the polarization-sensitive device comprises one of a polarizer or a polarization splitter.

28. The converter of claim 26 wherein the second conversion stage further comprises a polarization controller configured to cancel random polarization fluctuations in the optical signal output by the birefringement medium before it is received by the polarization-sensitive device.

29. The converter of claim 26 further comprising a photodetector disposed at an output of the second conversion stage configured to detect the corresponding intensity-modulated signal.

30. The converter of claim 24 wherein the selected differential group delay between the first and second main axes of symmetry is substantially equal to a bit period of the optical input signal such that the birefringent medium converts the phase-modulated input signal into an intensity-modulated, non-return-to-zero format.

31. The converter of claim 24 wherein the selected differential group delay between the first and second main axes of symmetry is sufficiently less than the bit period of the optical input signal such that the birefringent medium converts the phase-modulated input signal into an intensity-modulated, return-to-zero format.

32. A method of converting a modulation format of an optical input signal, the method comprising:
inputting an optical input signal into a birefringent medium having first and second main axes of symmetry and a selected differential group delay between the first and second main axes; and
separating the optical input signal into two optical components such that each optical component travels along different ones of the first and second main axes at a different group velocity.

33. The method of claim 32 wherein the optical input signal to be converted comprises a phase-modulated optical signal, and wherein the method further comprises selecting the differential group delay of the birefringent medium such that a signal output by the birefringent medium comprises a corresponding polarization modulated signal.

34. The method of claim 33 further comprising converting the polarization-modulated signal into an intensity-modulated signal by applying the polarization-modulated signal to a polarization-sensitive device.

35. The method of claim 32 further comprising selecting the differential group delay of the birefringent medium based on a bit rate of the optical input signal such that the differential group delay is substantially equal to a bit period of the optical input signal.

36. An optical signal receiver configured to detect a phase-modulated optical input signal, the optical signal receiver comprising:
a first optical signal modulation format conversion stage comprising a birefringent medium having first and second main axes of symmetry, and a selected differential group delay between the first and second main axes of symmetry, and configured to separate a phase-modulated optical input signal passing through the first and second main axes into two optical components such that each optical component travels along different ones of the first and second main axes at a different group velocity to obtain a polarization-modulated signal; and
a second conversion stage comprising:
a polarization-sensitive device configured to convert the polarization-modulated signal into a corresponding intensity-modulated signal; and
a photodetector for detecting the intensity-modulated signal.
